(19) United States
(12) Patent Application Publication
(10) Pub. No.: US 2006/0206311 A1
(43) Pub. Date: Sep. 14, 2006

(54) System and method of multilingual rights data dictionary

(76) Inventors: Sang-Won Jeong, Seoul (KR); Weon-Geun Oh, Daejon (KR); Ki-Song Yoon, Daejon (KR)

Correspondence Address: LADAS & PARRY LLP, 224 SOUTH MICHIGAN AVENUE, SUITE 1600, CHICAGO, IL, 60604, US

(21) Appl. No.: 10/565,132

(22) PCT Filed: Dec. 30, 2003
(86) PCT No.: PCT/KR03/02915

§ 371 Date: Mar. 29, 2006

(30) Foreign Application Priority Data
Jul. 18, 2003 (KR) 10-2003-0049397
Dec. 29, 2003 (KR) 10-2003-0098791

(51) Int. Cl. G06F 17/21

(52) U.S. Cl. 704/10

(57) ABSTRACT

System and method of a multilingual rights data dictionary is provided. The system and method provides a multilingual RDD registry to local system for translating rights terms. The system includes the RDD registry and processor for translating the rights term by referring to the registry.

### TECHNICAL FIELD

The present invention relates to a system for implementing a multilingual rights data dictionary (RDD) and a method for referring to the RDD.

### BACKGROUND ART

A rights data dictionary (RDD) of a Moving Picture Expert Group-21 (MPEG-21) is a collection of standardized terminology for describing all types of rights and permissions for supporting commercial transaction of digital contents based on an Interoperability of Data in E-Commerce Systems (INDECS) framework. Because a purpose of the RDD is to exchange and process precise information on management and usage of the rights relevant to digital contents, it is very important to clearly understand the RDD.

In an MPEG-21 framework environment, every MPEG tool should be able to understand and implement the rights designated by a rights holder of a digital item. The RDD and a rights expression language (REL) operate as standards satisfying the above requirement.

The REL is a machine-readable language which can express the rights and permissions by using terms defined in the RDD. The REL expresses the usage, the rights and the rule in Extensible Markup Language (XML) and it is used as an expression tool for managing the rights of the MPEG-21.

The RDD is a standard which is a semantic base of all expressions about the rights and permissions provided by the REL. The RDD includes a set of clear, consistent, integrated and uniquely identified terms, and becomes a semantic layer for information processing of the rights and the permission by supporting the MPEG-21 REL. Thus, the RDD provides clear and perfect definitions of the terms used in the REL and enables those related to the rights management of the MPEG-21 digital item and the usage thereof (i.e., the rights holder, a contents provider, a distributor, an end user, a system thereof, and etc.) to precisely exchange and process the information.

The RDD structure of the MPEG-21 is provided according to methodologies for dictionary compilation. The RDD defines one meaning for one term expressed with a specific Headword, and also it is an inclusive dictionary in that it supports mapping of one term in a certain namespace (authority) to another one defined in another namespace (authority). The RDD is designed to define the terms used in the REL, and also to support the mapping of metadata from the terminology of one namespace to that of another in another namespace automatically or semiautomatically while minimizing ambiguity and loss of semantic consistency.

FIG. 1 is a block diagram describing standard attributes RDD terms. As shown, the RDD terms includes a Headword, a Description, a Synonym, a Genealogy, a TermStatus, a Family, a ContextDescription, a Relationship and the like as standard attributes. Each attribute includes a Language, an Authority, a type, and Comment as Subordination attributes.

The RDD is a logical model and is based on a Context model. In the Context model, meanings of basic terms are presented as <Table 1>.

TABLE 1

| Basic term | Meaning |
|---|---|
| Agent | A subject of activity such as an individual, an organization, |
| | a system, and the like. |
| Context | A situation where an activity is occurred. |
| Time | Time context where an activity is occurred. |
| Place | A place context where an activity occurs. |
| Resource | Entities related to contexts except Agent, Time and Place. |

FIG. 2 is a block diagram illustrating the Context model of the RDD. In the RDD, a Family is a relational group determining attributes inherited from one term to another term according to the Context model, and is divided into an ‘Action Family’ and a ‘Context Family’, and derivative words are generated.

The ‘Action Family’ includes settings of relations between an ActType and a term and is derived by applying the Context model. For example, term types of the Context model in the ‘Action Family’ of ‘Make’ are as follows.
1. Make→BegetsContextType→MakingEvent
2. Make→BegetsAgentType→Maker
3. Make→BegetsResourceType→Output
4. Make→BegetsResourceType→MakingTool
5. Make→BegetsTimeType→TimeOfMaking
6. Make→BegetsPlaceType→PlaceOfMaking

The ‘Context Family’ has the same structure as the ‘Action Family’, but differently from the ‘Action Family’, it derives new terms only when mapping or a function of another RDD needs to be supported.

In the ‘Context Family’ of the MakingEvent, Quality Type relations are as follows.
1. MakingEvent→BegetsQualityType→Makeable
2. MakingEvent→BegetsQualityType→Making
3. MakingEvent→BegetsQualityType →Made
4. MakingEvent→BegetsQualityType →BeingMade

As shown, because the RDD is a semantic layer of rights, it is very important that a DRM system precisely understand original meaning in the MPEG-21 framework environment. However, as above-mentioned, the RDD is described in English. Due to original characteristics of the natural language, when the official language of RDD, or English is translated into another language, meanings can be transmuted or reduced. For example, when an intellectual property management & protection (IPMP) tool using a language which is not English interprets the rights in content describing content usage contract using the RDD terms, the meaning of the rights in content can be distorted. Furthermore, in a global transaction environment, it is difficult to make digital content distribution framework which guarantees interoperability, which is the aim of the MPEG-21, without a standardized method for sharing and exchanging of RDD term information even though the same RDD standard is used.

### DISCLOSURE OF INVENTION

It is, therefore, an object of the present invention is to solve the above-mentioned problem and there is provided a multilingual rights data dictionary (RDD) system and a method for referring to the RDD, wherein the RDD system can guarantee interoperability among systems by registering standardized term definitions in a multilingual RDD registry for each language and by interpreting rights term which refers to the multilingual RDD registry in various language-based systems.

Other objects and advantages of the present invention will be described hereinafter, and will be recognized according to an embodiment of the present invention. Also, the objects and the advantages of the present invention can be implemented in accordance with means and combinations of the means shown in claims of the present invention.

In accordance with one aspect of the present invention, there is provided a local system of an RDD that can connect to a central system having an RDD registry, the local system including: a local RDD registry for storing RDDs of a specific language; and a processing unit for parsing an inputted rights term and interpreting the rights term by referring to the local RDD registry, and wherein the processing unit acquires rights term interpreting information based on the multilingual RDD registry by connecting to the central system when the rights term interpreting information does not exist in the local RDD registry.

In accordance with another aspect of the present invention, there is provided a central system of an RDD that can connect to multiple local systems, the central system including: a multilingual RDD registry; and a processing unit for receiving a rights term from the connected local system, extracting interpreting information of the rights term based on the multilingual RDD registry and transmitting the interpreting information.

In accordance with still another aspect of the present invention, there is provided a method for referring to an RDD which acquires rights term interpreting information by connecting to a central system having the multilingual RDD, the method including: receiving a rights term; parsing the rights term; extracting interpreting information of the rights term from the local RDD registry storing RDDs of a specific language; and receiving the rights term interpreting information based on the multilingual RDD registry by connecting to the central system when the rights term interpreting information does not exist in the local RDD registry.

In accordance with further still another aspect of the present invention, there is provided a method for referring to an RDD in a central system having a multilingual RDD registry, the method including: receiving a rights term from a local system having a local RDD registry; and extracting interpreting information of the rights term based on the multilingual RDD registry and transmitting the rights term interpreting information to the local system.

### BRIEF DESCRIPTION OF DRAWINGS

The above and other objects and features of the present invention will become apparent from the following description of the preferred embodiments given in conjunction with the accompanying drawings, in which:

FIG. 1 is a block diagram describing standard attributes of a rights data dictionary (RDD) term;

FIG. 2 is a block diagram describing a context model of an RDD;

FIG. 3 is a block diagram describing a process referring to a multilingual RDD registry in accordance with the present invention;

FIGS. 4A to 4P show Extensible Markup Language (XML) schema of an RDD stored in a local RDD registry in accordance with the present invention;

FIG. 5 shows an XML document of a Korean RDD in accordance with the present invention; and

FIG. 6 is a flowchart describing a process referring to a multilingual RDD registry in accordance with a preferred embodiment of the present invention.

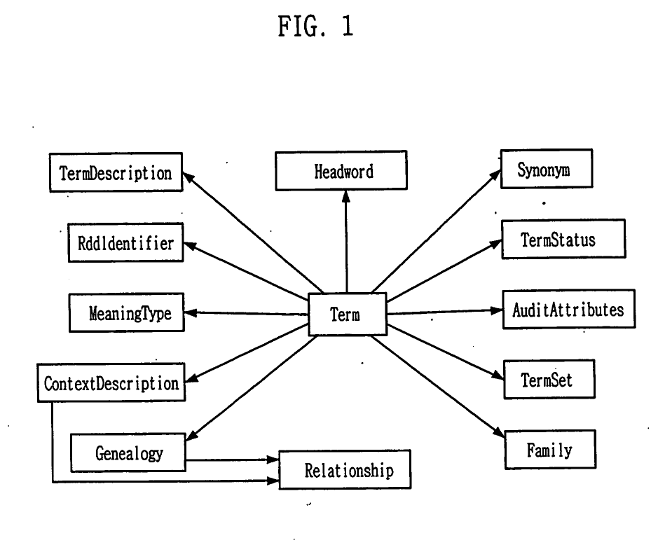

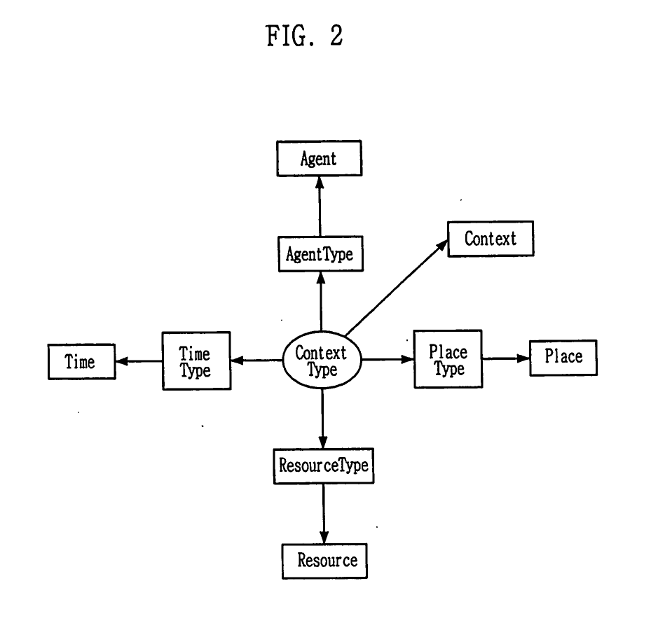

### BEST MODE FOR CARRYING OUT THE INVENTION

A preferred embodiment of the present invention will described with reference to the accompanying drawings, which is set forth hereinafter. Prior to this, the terms and words used in the present specification and claims should not be construed to be limited to the common or dictionary meaning, because an inventor can define the concept of the terms appropriately to describe his/her invention in the best manner. Therefore, they should be construed as a meaning and concept fit to the technological concept and scope of the present invention.

Therefore, the embodiments and structure described in the drawings of the present specification are nothing but preferred embodiments of the present invention, and they do not represent all of the technological concept and scope of the present invention. Therefore, it should be understood that there can be many equivalents and modified embodiments that can substitute those described in this specification.

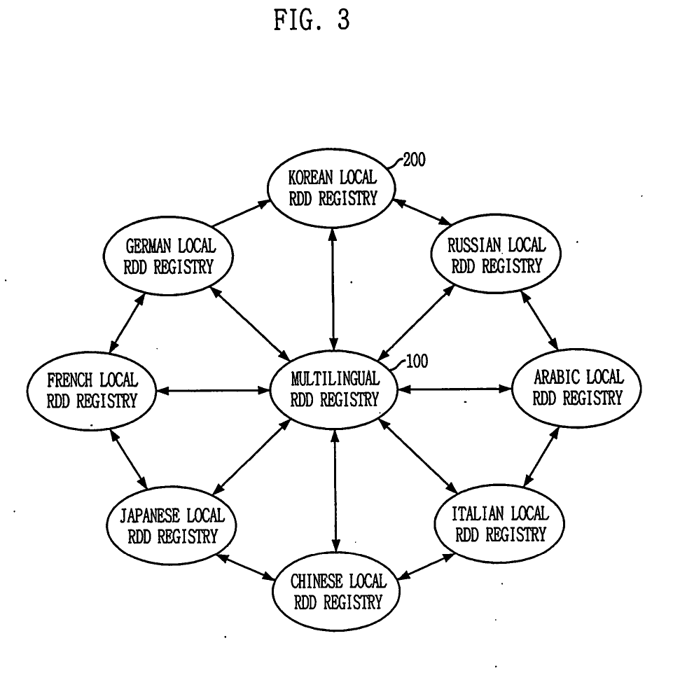

FIG. 3 is a block diagram describing a process referring to a multilingual rights data dictionary (RDD) registry in accordance with the present invention. As shown, the multilingual RDD registry 100 can be implemented in a central system. Also, the central system and a local system connected through a network can include a local RDD registry 200.

The local system includes intellectual property management & protection (IPMP) interpreting MPEG-21 framework-based rights terms, a digital item adaptor (DIA) and a digital item processor (DIP).

The local RDD registry 200 stores rights terms standardized for each language according to characteristics to which the local system belongs.

The multilingual RDD registry 100 is an aggregate of the local RDDs of individual languages and it maps rights terms among different languages. Accordingly, the local system of a language can use the RDD of another language by connecting to the central system through the network when interpreting the rights terms.

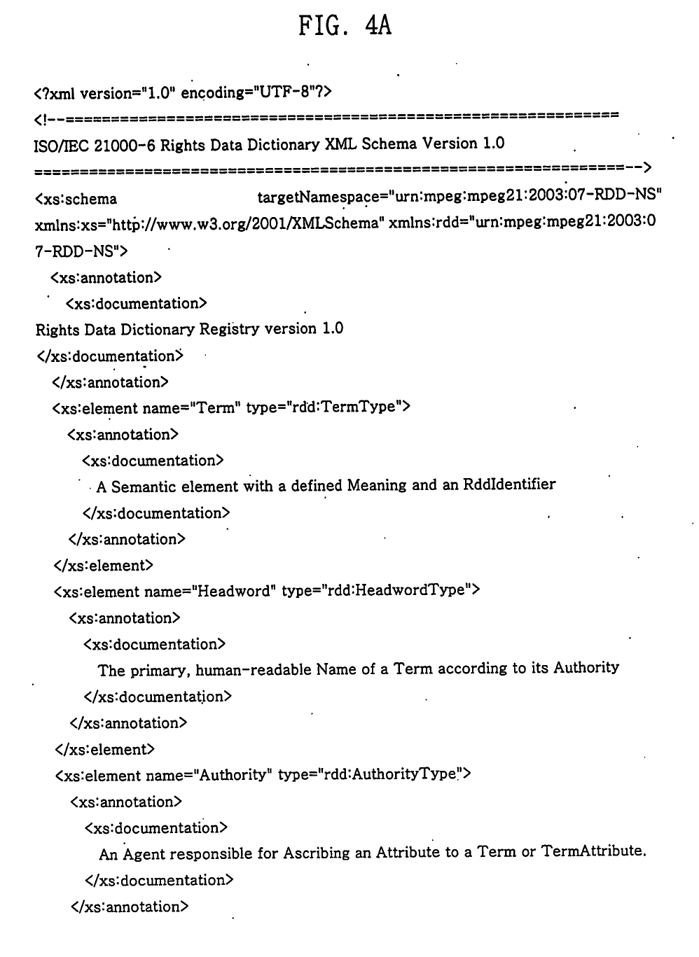

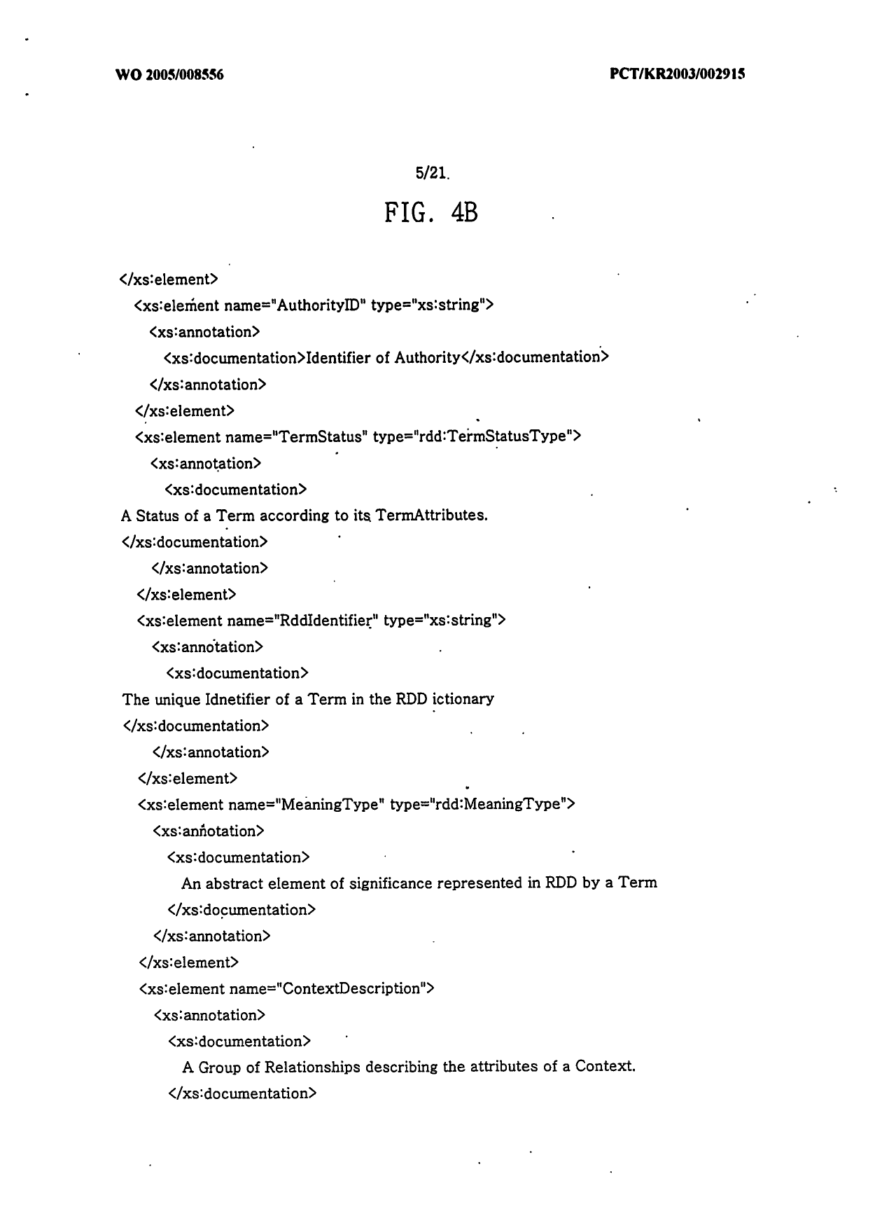

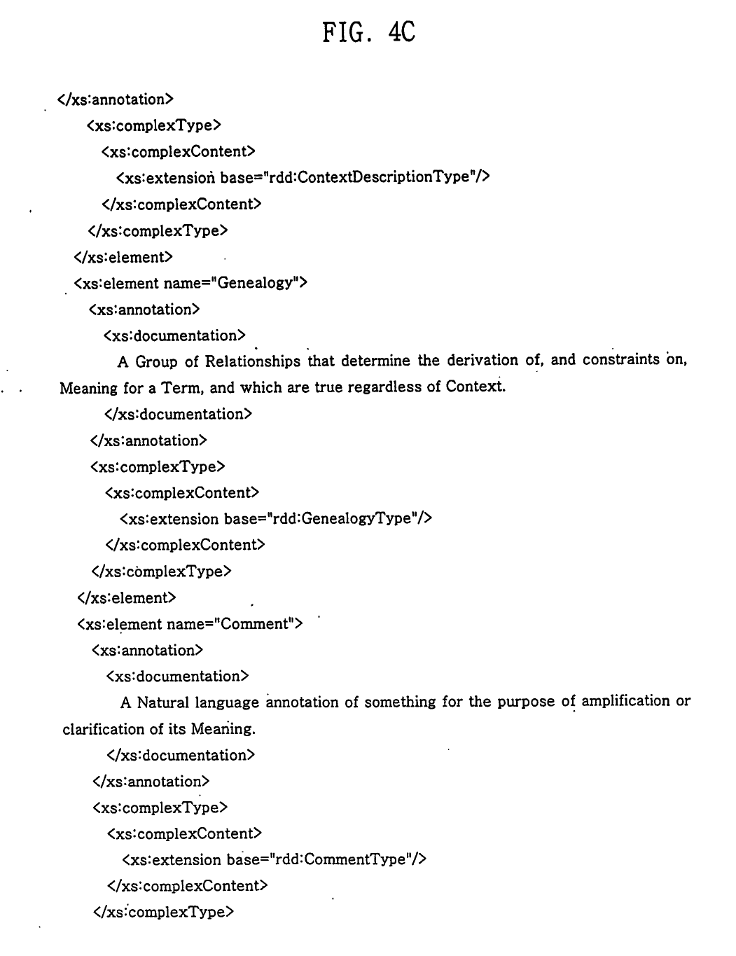

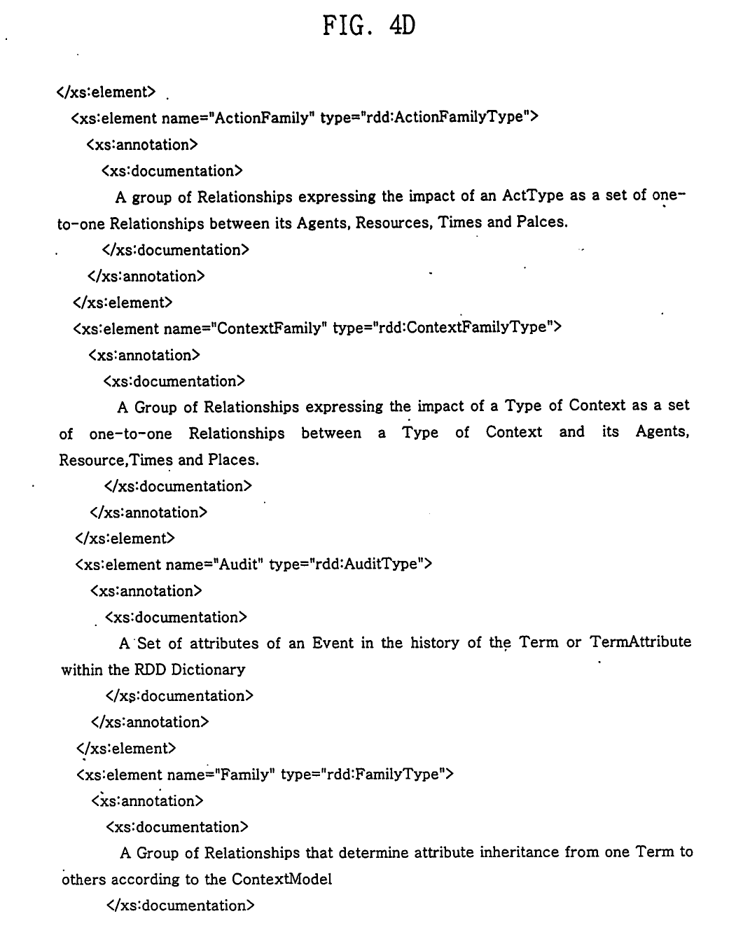

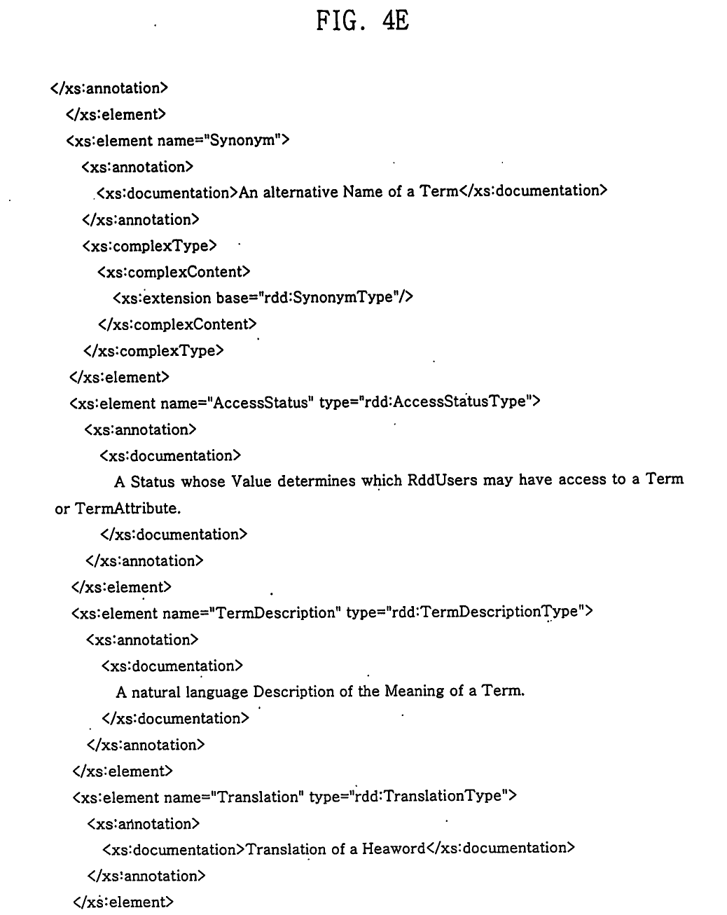

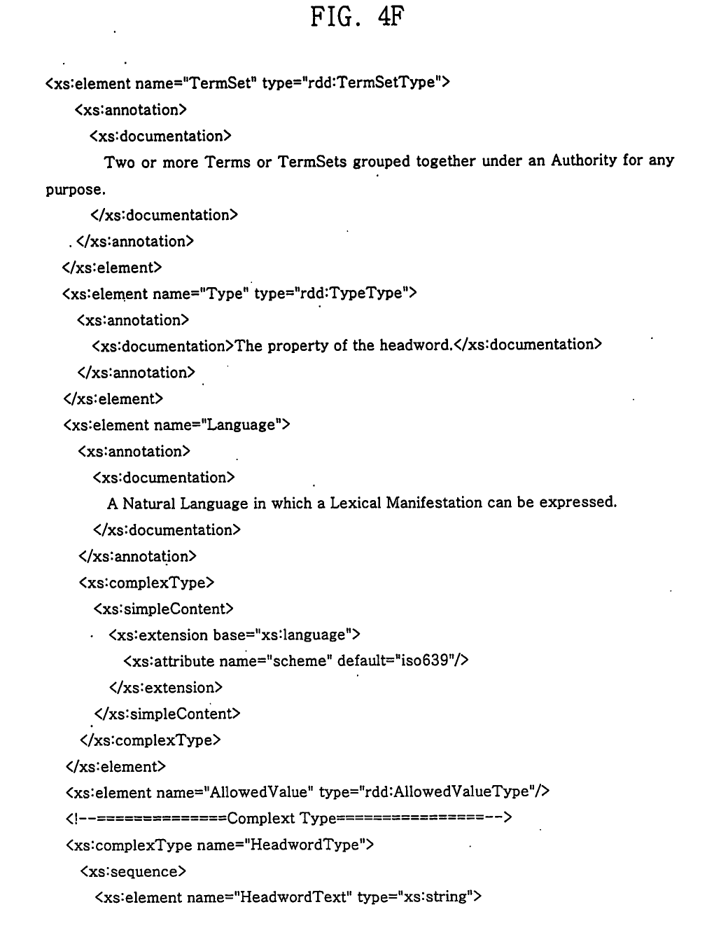

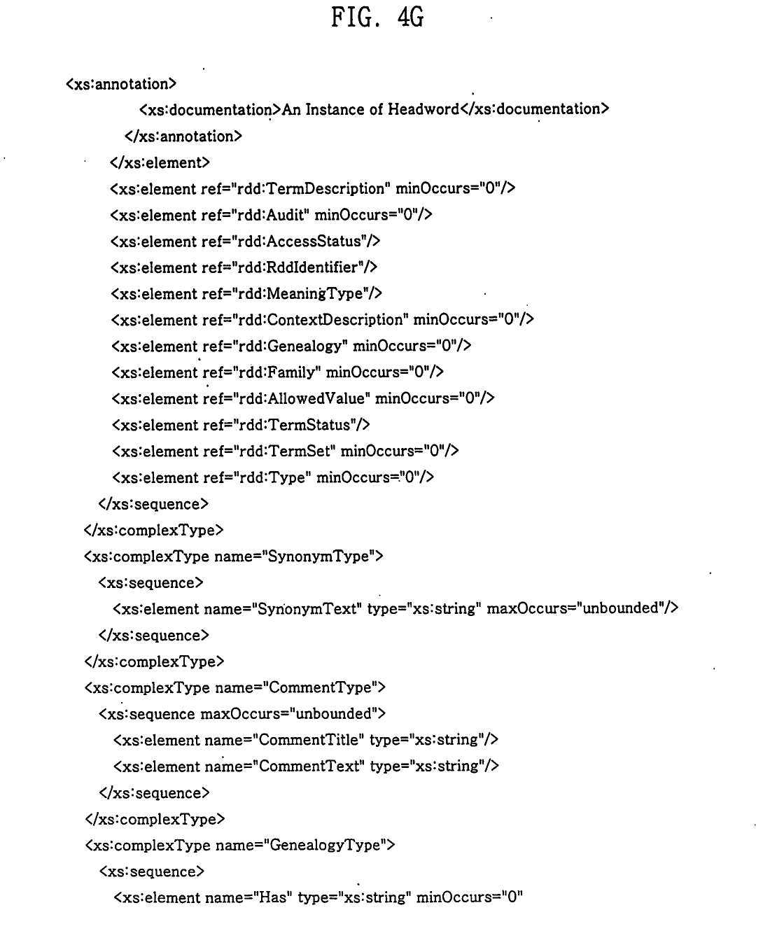

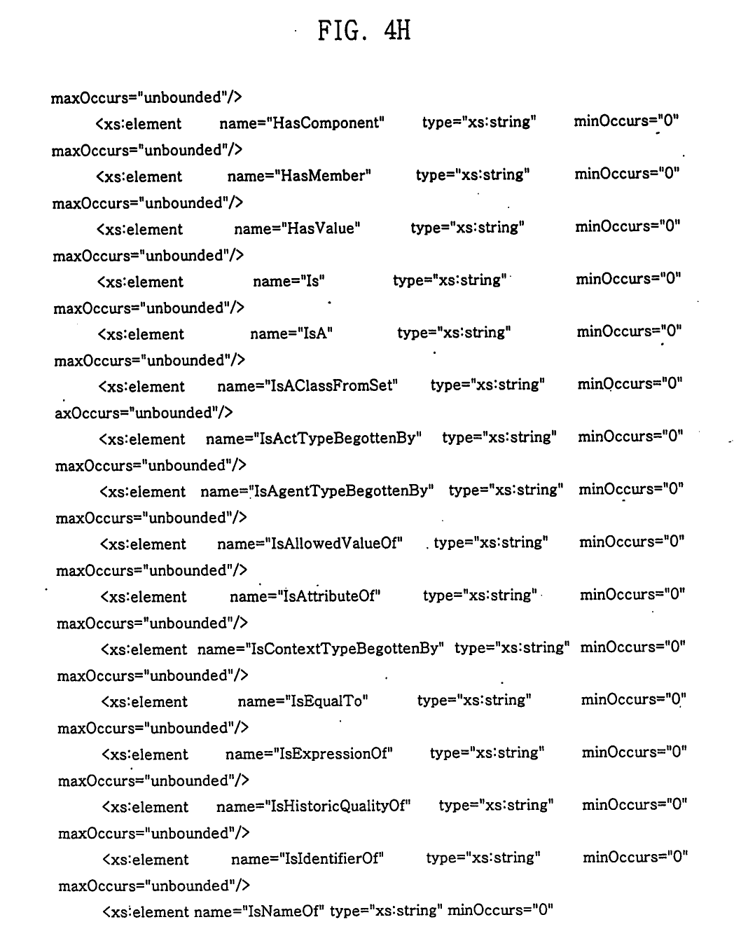

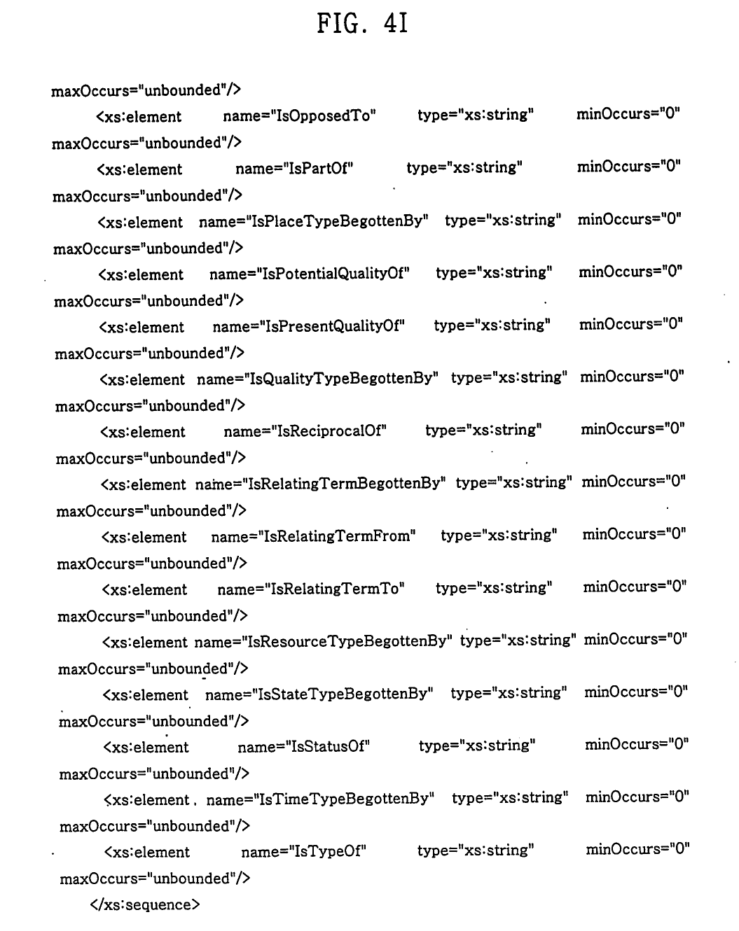

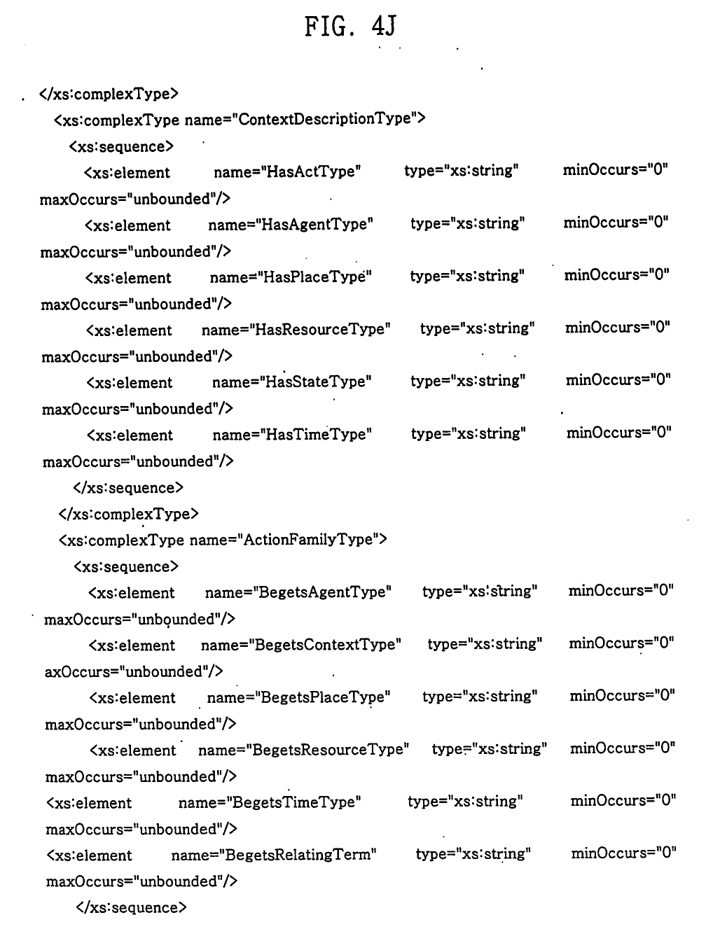

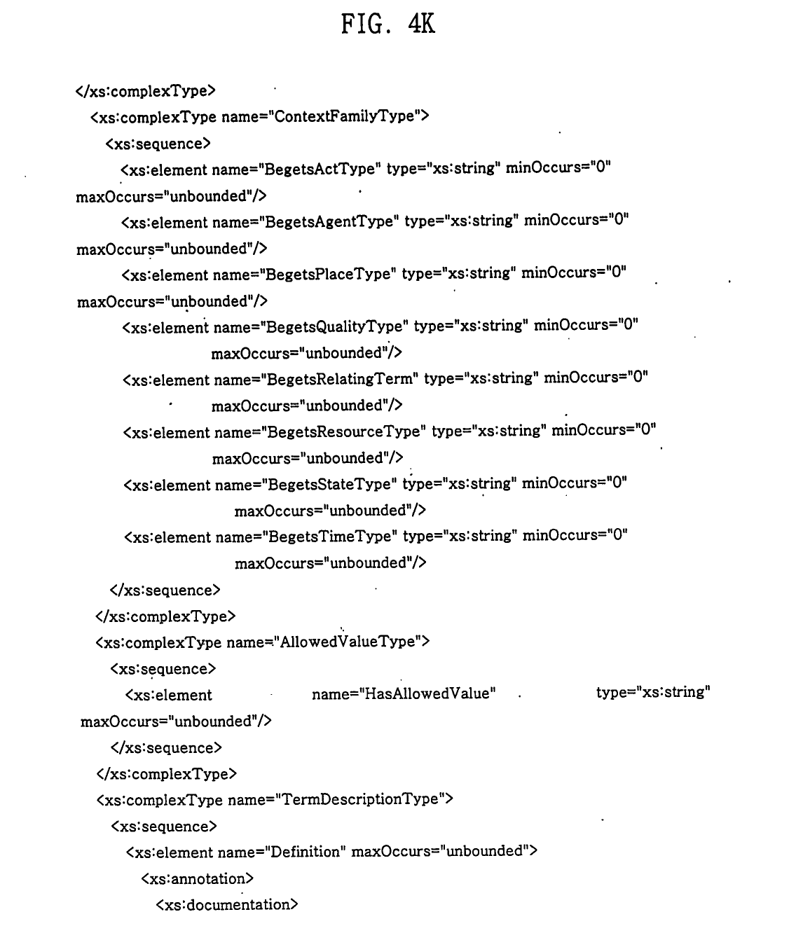

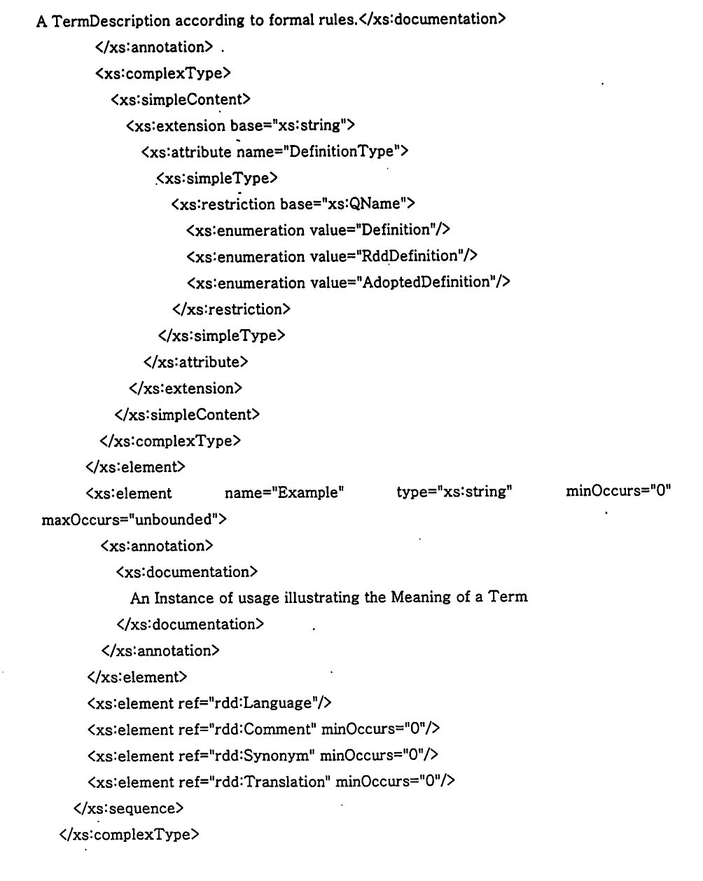

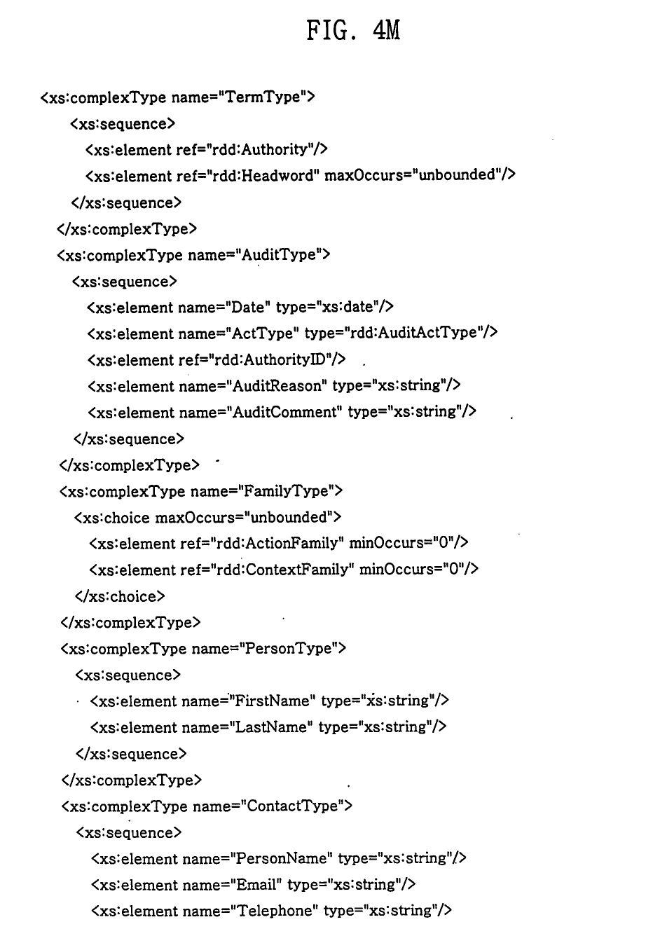

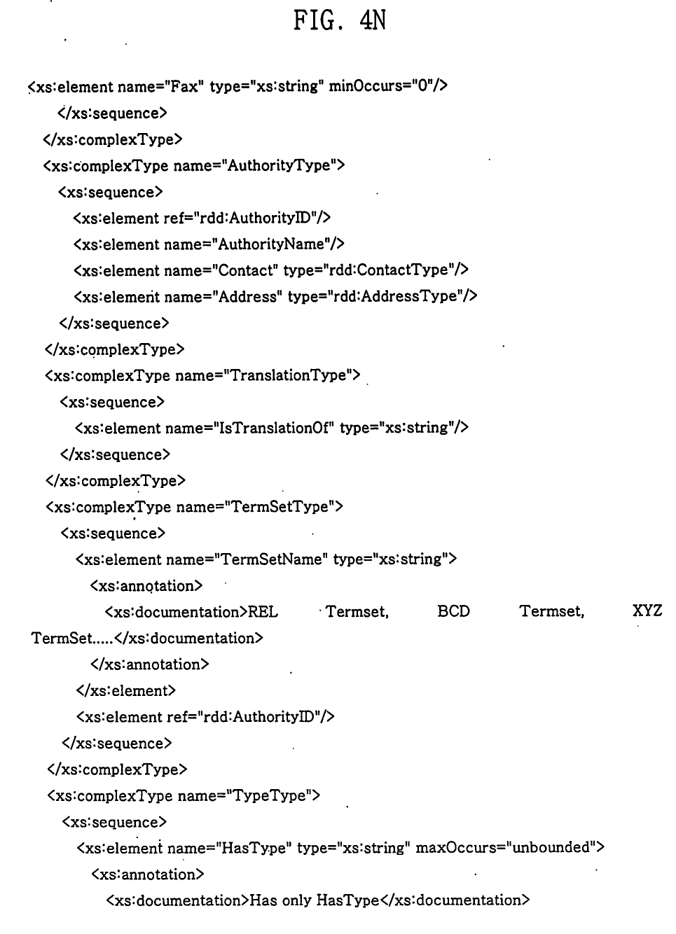

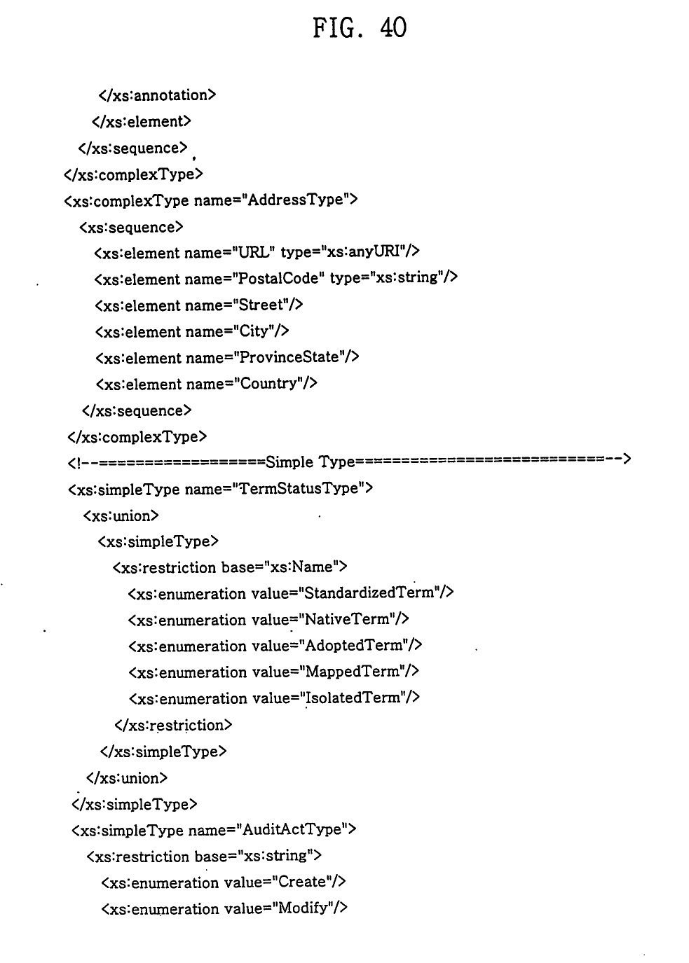

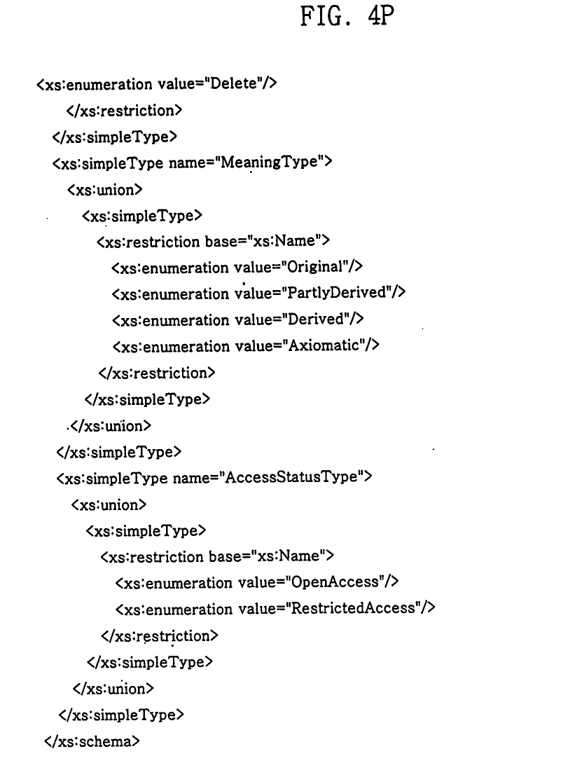

FIGS. 4A to 4P show Extensible Markup Language (XML) schema of the RDD stored in the local RDD registry in accordance with the present invention. As shown, the XML schema of the rights terms reflects standard attributes of the MPEG-21 RDD.

That is, ‘Headword’, ‘Description’, ‘Synonym’, ‘Genealogy’, ‘TermStatus’, ‘Family’, ‘ContextDescription’, ‘Relationship’ and the like are described basically with respect to the rights term of individual language. Also, each attribute can include subordination attributes like ‘Language’, ‘Authority’, ‘Type’, ‘Comment’, etc.

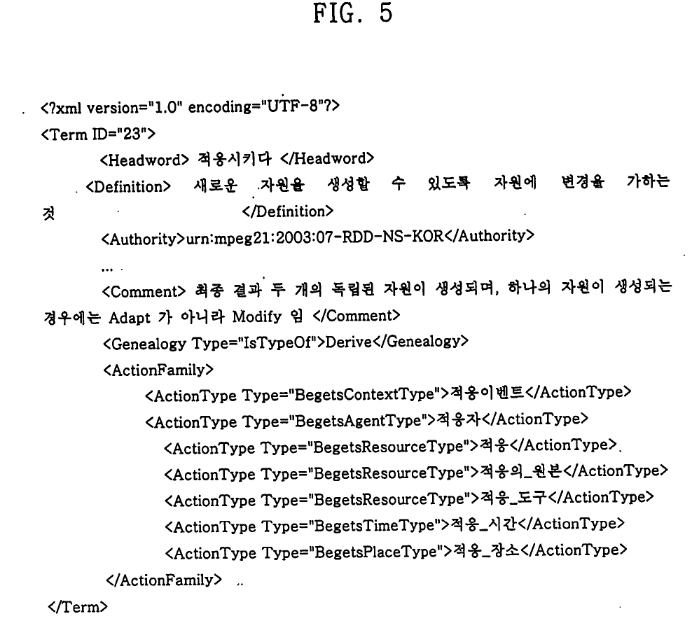

FIG. 5 shows an XML document of a Korean RDD in accordance of the present invention. As shown, in attributes of a Headword [symbol] (which is a Korean word meaning ‘adapt’ in English) is described and stored at the local RDD registry 200.

Meanwhile, because the multilingual RDD registry is an aggregate of the RDDs of individual languages, the multilingual RDD registry has the rights term interpreting information of another language, which is required by the local system.

In order to map the rights terms among different languages, the multilingual RDD registry includes a logical link for a registered Headword.

In a preferred embodiment of the present invention, various language RDDs can be linked by adding <IsTranslationOf> attribute to the Headword of each rights term. For example, a rights term [symbol] standardized by Korean can be mapped precisely to ‘Adapt’ of MPEG-21 RDD by adding <IsTranslationOf> Adapt </ISTranslationOf> to the Headword of the Korean attribute [symbol] .

In another embodiment, a standardized rights term of individual language can be precisely mapped by giving the identical ID (e.g., identical number) to rights terms which have the identical meaning by using an <RddIdentifier> attribute.

Furthermore, the method for mapping and extracting rights terms between different languages by using the multilingual RDD registry 100 including the RDDs of individual languages.

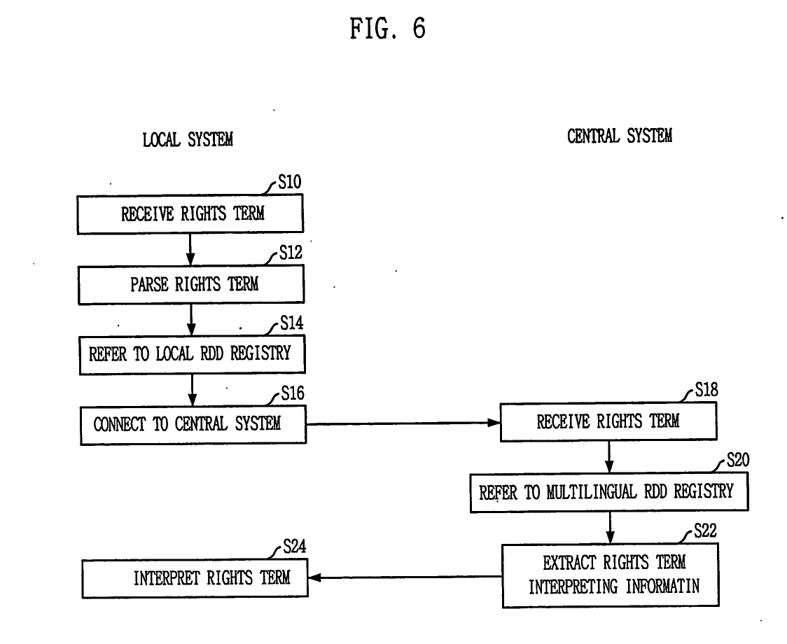

FIG. 6 is a flowchart describing a process of referring to the multilingual RDD registry in accordance with a preferred embodiment of the present invention. Hereinafter, the local system includes the local RDD registry which stores the specific language RDD, and a processor which controls the overall local system according to a series of processes described below and interprets inputted rights terms. Also, the central system includes the multilingual RDD registry which stores the RDDs of all kinds of languages included in the local system and a processor which controls the overall central system according to a series of processes described below and extracts interpreting information of the rights term inputted by the local system.

As shown, first of all, the local system receives the rights term (e.g., an XML document including the rights terms) from various sources at step S10 and interprets the inputted rights term by parsing the rights term at step S12. The local system refers to the local RDD registry in order to interpret the rights term at step S14.

Because the local RDD registry of the present invention stores the interpreting information of standardized rights term of a specific language, the rights term of another language does not exist in the local RDD registry.

If the rights term inputted to the local system is a rights term of another language, which does not exist in the local RDD registry, the local system connects to the central system at step S16 and inputs the rights term to the central system at step S18.

The central system refers to the multilingual RDD registry at step S20, extracts interpreting information of the rights term and transmits the interpreting information to the local system at step S22.

The local system interprets the rights term based on the interpreting information at step S24.

The multilingual RDD registry includes an aggregate of individual local RDD and a link which connects the local RDDs logically, and extracts interpreting information of the rights term based on the link.

Also, in another embodiment of the present invention, it is possible that the multilingual RDD registry includes only link information which connects the local RDDs logically, connects to another local system based on the link information and extracts interpreting information of the rights term from another local RDD registry.

In this case, the central system can transmit the rights term interpreting information which is extracted from the local RDD registry to the local system which requires the rights term interpreting information.

Meanwhile, in the above case, the central system may transmit the link information which is needed to connect to another local RDD registry having the rights term interpreting information (e.g., location information (URL value)) instead of transmitting the rights term interpreting information to the local system requiring the rights term interpreting information. The local system that has received the link information can acquire the needed rights term interpreting information by connecting to a specific node having a specific language RDD registry.

In the present invention described above, the multilingual RDD registry can be utilized for various applications, for example, intellectual property management & protection (IPMP), digital item processor (DIP) and ER which use a specific language in various languages, locations and countries, and, in particular, the multilingual RDD registry supports development of application software in the REL and the ER field.

Also, the multilingual RDD registry can provide infrastructure which is needed for data sharing and exchange by securing reliability among MPEG-21 systems which use different languages.

While the present invention has been described with respect to certain preferred embodiments, it will be apparent to those skilled in the art that various changes and modifications may be made without departing from the scope of the invention as defined in the following claims.

What is claimed is:

1. A local system of a multilingual rights data dictionary (RDD), for connecting to a central system having a multilingual RDD registry, the local system comprising:
a local RDD registry for storing an RDD of a specific language; and
a processing means for parsing a rights term and interpreting the rights term by referring to the local RDD registry,
wherein the processing means acquires rights term interpreting information based on the multilingual RDD registry by connecting to the central system when the rights term interpreting information does not exist in the local RDD registry.

2. The local system as recited in claim 1, wherein the multilingual RDD registry includes:
a set of local RDDs of a specific language stored in a plurality of local systems; and
a link for connecting the local RDDs logically,
wherein the rights term interpreting information is extracted based on the link.

3. The local system as recited in claim 1, wherein the processing means acquires the rights term interpreting information from the local RDD registry of another local system linked to the multilingual RDD registry.

4. A central system of a multilingual rights data dictionary (RDD), for connecting to a plurality of local systems, the central system comprising:
a multilingual RDD registry; and
a processing means for receiving a rights term from the connected local system, extracting interpreting information of the rights term based on the multilingual RDD registry and transmitting the interpreting information.

5. The central system as recited in claim 4, wherein the multilingual RDD registry includes:
a set of local RDDS of a specific language stored in a plurality of local system; and
a link for connecting the local RDDS logically,
wherein the processing means extracts the rights term interpreting information based on the link.

6. A central system of a multilingual rights data dictionary (RDD), for connecting to a plurality of local systems, the central system comprising:
a multilingual RDD registry for including link information which logically connects local RDD registries maintained by the local systems; and
a processing means for receiving a rights term from the connected local system and transmitting information which is needed to interpret the rights term based on the multilingual RDD registry to the local system.

7. A method for referring to a multilingual rights data dictionary (RDD) which acquires rights term interpreting information by connecting to a central system having the multilingual RDD, the method comprising the steps of:
a) receiving a rights term;
b) parsing the rights term;
c) extracting interpreting information of the rights term from a local RDD registry storing an RDD of a specific language; and
d) receiving the rights term interpreting information based on the multilingual RDD registry by connecting to the central system when the rights term interpreting information does not exist in the local RDD registry.

8. The method as recited in claim 7, wherein the multilingual RDD registry includes:
a set of local RDDs of specific languages stored in a plurality of local systems; and
a link for connecting logically local RDDs,
wherein the rights term interpreting information is extracted based on the link in the step d).

9. The method as recited in claim 7, wherein the step d) includes the step of:
acquiring the rights term interpreting information from the local RDD registry of another local system linked to the multilingual RDD registry.

10. A method for referring to a multilingual rights data dictionary (RDD) in a central system having a multilingual RDD registry, the method comprising the steps of:
a) receiving a rights term from a local system having a local RDD registry; and
b) extracting interpreting information of the rights term based on the multilingual RDD registry and transmitting the rights term interpreting information to the local system.

11. The method as recited in claim 10, wherein the multilingual RDD registry includes:
a set of local RDDs of a specific language stored in the local systems; and
a link for connecting the local RDDs logically,
wherein the rights term interpreting information is extracted based on the link in the step b).
